(19) United States
(12) Patent Application Publication
(10) Pub. No.: US 2015/0098077 A1
(43) Pub. Date: Apr. 9, 2015

(54) TAG HAVING AN OPTICAL FIBRE SENSOR

(71) Applicant: Buddi Limited, Aylesbury (GB)

(72) Inventor: Ewan Donald Findlay, Aylesbury (GB)

(21) Appl. No.: 14/484,781

(22) Filed: Sep. 12, 2014

(30) Foreign Application Priority Data
Sep. 12, 2013 (GB) 1316273.0

(51) Int. Cl. G01M 11/02; G01N 25/00; G01N 21/71

(52) U.S. Cl. CPC G01M 11/02; G01N 21/71; G01N 25/00; G01N 2201/08
USPC 356/73.1

(57) ABSTRACT

A tag for securing to a person or object, comprising at least one fibre optic sensor having a plastics optical fibre that changes optical transmission characteristics with a change in temperature, and a sensor unit coupled to the optical fibre. The sensor unit is configured to detect change in the characteristic of optical transmission. The optical fibre is coupled to a locking strap to extend around a portion of a person or object. A detectable increase in attenuation of light transmitted through the optical fibre may occur when the temperature of the optical fibre is increased from a normal use temperature to at least a threshold temperature, which may be in the vicinity of the softening temperature of the optical fibre. The optical fibre may be used in electronic tags for offender monitoring to ensure the continuity of the strap, and to detect softening and stretching of the optical fibre.

### FIELD OF THE INVENTION

The invention relates to a tag having an optical fibre sensor. The invention also relates to a method of making an optical fibre.

### BACKGROUND

It is desirable to monitor location of certain people. Electronic tagging is a tool for courts, penal institutions or hospital facilities, for example, to manage persons within their facilities and externally. Electronic tagging may be used with offenders in pre-trial and post-release management of the person monitored. Release may be subject to certain conditions, for example the offender may not be allowed to leave a particular area between certain times, or may not be allowed to enter a particular area. Use of tagging instead of imprisonment reduces prison population and provides a convenient way of verifying that the offender obeys conditions of release.

To enable monitoring of a person, a tracking device is securely attached to the person. Wearers of such devices may try to remove them so as to escape and avoid being monitored. It is important that the tracking device cannot be removed, or if the tracking device is removed then its removal is detected so that appropriate measures can be taken.

Typically, an electronic tag comprises a tracking device and a strap, the strap securing the tracking device around a person's ankle or wrist. It is known to include a wire in the strap through which an electrical signal can be sent to confirm that the strap is in place. If the electrical signal cannot travel through the strap, it can be understood that the strap is broken. However, it is still possible to break the strap while maintaining an electrical signal between ends of the strap by electrically connecting the ends.

It is also known to include an optic fibre sensor including an optical fibre that loops around the wearer's ankle or wrist inside the strap. An example is disclosed in US2011/0248853. In this example, an optical signal is periodically sent through the optical fibre and detected after it has passed through the optical fibre. If the pulse is not detected, the tracking device is configured to generate and send an alert for receipt by an appropriate authority.

Optical fibres included in tags are often formed of thermoplastic, particularly PMMA. A problem with conventional electronic tags is that the thermoplastic optical fibres can be heated and, once softened, stretched. PMMA has a melting point of 160° C. and softens at below this temperature. Once stretched, an offender can remove the electronic tag over a foot or wrist. Since the optical fibre is not broken, the periodic pulses can still travel around the fibre and the appropriate authorities are not notified that the location of the offender is no longer being monitored.

While optical fibres are also often made from silica, optical fibres for use in sensors for electronic tags are typically not made of silica since such fibres are too stiff for use in a strap, impede adjustability of the strap, and require a high processing cost for use in an electronic tag.

In view of the importance of providing reliable monitoring of offenders and other persons of interest, it is a serious problem that they can remove their tags without triggering an alert.

### SUMMARY OF THE INVENTION

According to a first aspect of the present invention, there is a provided a thermo-chromatic, plastics optical fibre. Such an optical fibre may be included in an electronic tag, and usefully permits detection of an attempt to heat the optical fibre to a temperature at which it can be stretched.

Use of such an optical fibre is not limited to offender monitoring. Such an optical fibre may be used in a security tag for securing to an object to monitor the object. Such an optical fibre may also be used more generally in many sensing applications where undetected thermal damage may alter the function of the fibre-sensor.

Preferably, the optical fibre is open at each end for transmission of light therethrough.

A detectable increase in attenuation of light transmitted through the optical fibre preferably when the temperature of the optical fibre is increased from a normal use temperature to at least a threshold temperature. Preferably, the threshold temperature is at least 80° C.

The optical fibre may have a softening temperature, wherein the detectable increase occurs to at least the threshold attenuation when the temperature of the optical fibre is in the vicinity of the softening temperature. Preferably, the attenuation of the optical fibre increases to the threshold attenuation when the optical fibre is heated to greater than 20° C., more preferably 10° C., below the softening temperature, and/or no more than 50° C., more preferably no more than 20° C., yet more preferably no more than 10° C., above the softening point of the optical fibre.

Preferably, the softening temperature is a temperature at which a length of the material of the optical fibre softens to be stretchable by at least 1% of the length under a load of at least 100N. More preferably, the softening temperature is a temperature at which the length of the material softens to be stretchable by at least 1% of the length under a load of at least 500N. The softening temperature is preferably at least 90° C.

The threshold temperature is preferably less than 50° C. above the softening temperature of the optical fibre.

The threshold attenuation is preferably where the capability for transmission of light is reduced to less than 10% of the original capability, preferably less than 5% of the original capability, and preferably still less than 1% of the original capability.

The optical fibre may be formed of material that is stretchable at a softening temperature. The fibre may be formed of a thermoplastics material such as PMMA. The optical fibre preferably comprises a core substantially comprised of plastics material and a thermo-chromatic additive in the plastics material.

There may be provided a fibre optic sensor comprising the optical fibre described above and a sensor means operatively coupled to the optical fibre, wherein the sensor means is configured to detect the intensity of light transmitting through the optical fibre.

There may also be provided a tag for securing to a person or object, comprising the fibre optic sensor and a strap for securing around a portion of a person or an object to be tagged, wherein the optical fibre extends in the strap so as to extend with the strap around the portion.

The tag may further comprise a controller means operatively coupled to the sensor means, wherein the sensor means is configured to provide information indicative of intensity of incident light to the controller means, wherein the controller means is configured to determine, based on the received information and stored information indicative of the intensity of light transmitted into the optical fibre, whether the attenuation threshold is reached, and if so, to determine that an alarm condition is met.

Preferably, if the alarm condition is met, the controller means is configured to cause an alarm signal to be transmitted. Thus, the alarm signal may usefully notify a third party, for example the police, that a condition of an offender's release has been breached and the offender is no longer being monitored.

The tag may include a tracking device configured to transmit information indicative of location of the tag. Thus, the alarm signal may usefully notify a third party, for example the police, that the whereabouts of the offender may no longer be known.

In accordance with a second aspect of the present invention, there is provided a method of making an optical fibre, wherein a characteristic of optical transmission has an initial value, the method comprising: providing thermo-chromatic material for at least a core of an optical fibre; forming the optical fibre, for example in a fibre-drawing or extrusion process, from at least the thermo-chromatic material, wherein the characteristic changes from the initial value during the forming process; and returning the characteristic to its initial value. This addresses a difficulty in the manufacture of thermo-chromatic optical fibre that a fibre-drawing or extrusion process requires heating of the optical fibre to a temperature at which the attenuation of the optical fibre has transitioned from its initial value. Prior to the step of providing the thermo-chromatic material, the thermo-chromatic material may be formed by adding of a thermo-chromatic additive to plastics material.

The characteristic is attenuation of light of a first one or more wavelengths, e.g. from 4000 nm and 2 μm, transmitted through the optical fibre, wherein the returning comprises applying light of second predetermined one or more wavelengths, for example ultraviolet light in the range 200 nm and 400 nm, different to the light of the first one or more wavelengths to the core material.

It is noted that herein the disclosure of alternative values for the upper or lower limit of the permitted range of a parameter, that is, the softening temperature, or the threshold temperature on which the change in the character of optical transmission depends, or the threshold attenuation, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

### BRIEF DESCRIPTION OF THE FIGURES

For better understanding of the present invention, embodiments will now be described, by way of example only, with reference to the accompanying Figures, in which:

FIG. 1 is a perspective view of an electronic tag;

FIG. 2 shows diagrammatically some components of the electronic tag; and

FIG. 3 is an illustrative end view of an optical fibre.

### DETAILED DESCRIPTION OF EMBODIMENTS

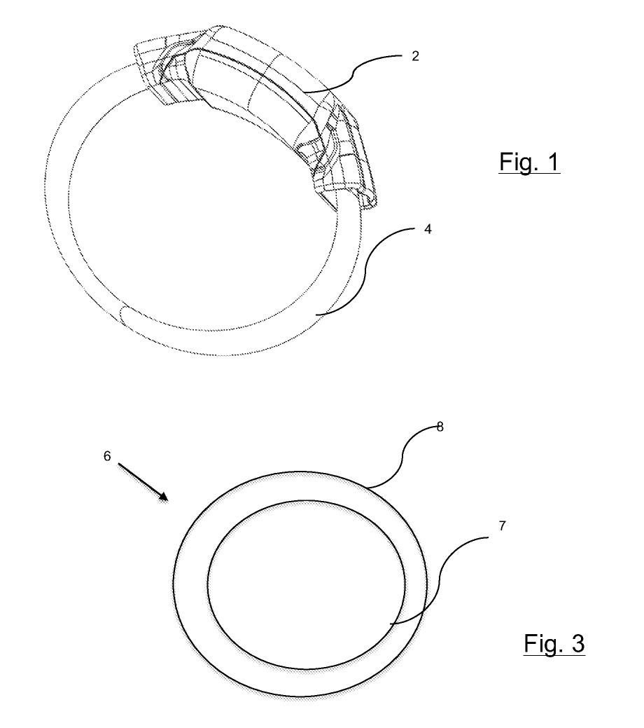

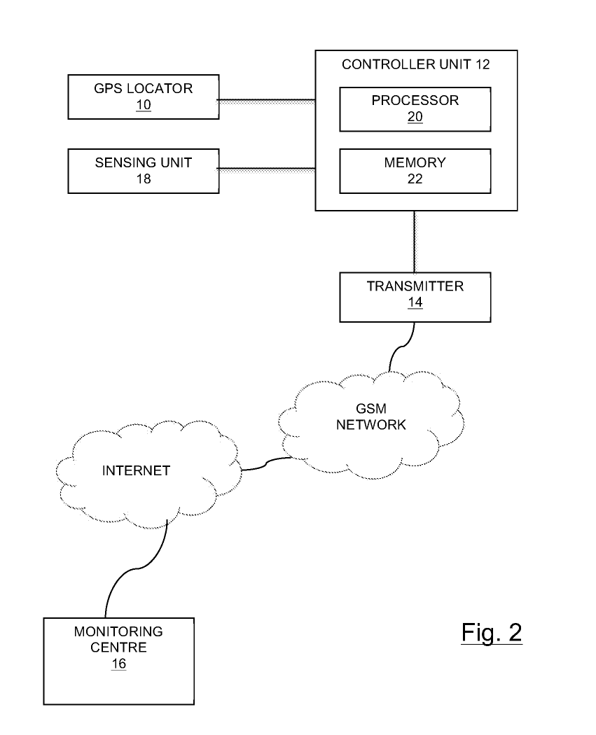

In the embodiment to be described, an optical fibre is part of an electronic tag for offender monitoring relating to location tracking. Referring to FIGS. 1 and 2, the electronic tag comprises a housing 2 and a locking strap 4 arranged to extend around an ankle. The housing 2 securely houses a tracking device, including all components necessary for tracking and for messages to be sent to a monitoring centre 16, and is configured to prevent the offender from tampering with components. These components include but are not limited, to a controller unit 12 operatively coupled to a global positioning system (GPS) locator 10 and a transmitter 14. The device may include more elements, as will be appreciated by a person skilled in the art. The GPS locator is capable of receiving signals in accordance with the GPS, processing those signals to determine location data indicative of the location of the device at particular times, and providing that location data to the controller unit 12, which provides the location data to the transmitter 14 for sending to the monitoring centre 16 via a wireless communications network.

Although the tracking device includes a GPS locator for determining location data, there are many other ways that the location (or approximate location) of the tracking device might be determined Embodiments of the invention are not limited to any particular way of generating location data. The tracking device could determine location using another kind of global satellite navigation system (GSNS). Other techniques for determining location could also be used, for example analysis of characteristics of signals to and/or from base stations in a surrounding mobile communications network. The location data does not have to be determined at the device; it could be determined in a wireless communications network, or at the server. Methods of determining the location of a device are known in the applicable art.

In this embodiment the wireless communications network is a GSM communications network, but the invention is not limited by the kind of network or networks with which the tracking device communicates. For example, the tracking device may be configured to communicate with a CDMA network, a Metropolitan Area Network, or a Local Area Network with appropriate range. The invention is also not limited to including any particular kind of network or networks that the location data passes through on the way to the monitoring centre 16.

The controller unit 12 includes at least one processor 20 and at least one memory 22 for storing location data to be sent and computer code comprising instructions executable by the at least one processor to carry out the functionality of the controller unit 12 described herein.

The tracking device includes a locking strap 4 enabling secure locking of the electronic tag to a limb of a person whose location is to be tracked. The locking strap 4 is configured to be releasable by an authorised party, for example a probation officer.

The locking strap 4 includes an outer protective sheath and, referring also to FIG. 3, an optical fibre 6 encased in the sheath. The optical fibre 6 comprises a core 7 and outer cladding 8. The material of the core 6 is poly(methyl methacrylate) (PMMA), which is a transparent thermoplastic, and a thermo-chromatic additive. The material of the outer cladding 8 is typically formed of fluorinated polymers, which typically causes light pulses to be confined to the core by total internal reflection at a boundary between the cladding 8 and the core 6. Both these materials are stretchable on heating. Accordingly, a wearer of the electronic tag may heat the optical fibre and stretch it without disrupting the continuity of the optical fibre. It is not essential for the fibre 6 to be formed of thermoplastic material; in other embodiments the fibre may be formed from a thermosetting plastic material. Also, the fibre 6 may be formed of a photonic crystal fibre formed, for example, of extruded plastic with air holes in.

In accordance with an aspect of the present invention, as a result of a thermo-chromatic additive, the material of the core 7 is configured to darken on heating. In other words, the attenuation coefficient of the material increases on heating.

The core darkens at above temperatures to which the optical fibre might normally become subject during use of the optical fibre. “Normal use temperatures” are those temperatures to which a wearer may cause the fibre to be exposed when engaging in everyday activities. Typically such activities would not normally cause the temperature of the optical fibre to exceed about 50 degrees.

The temperature at which the core darkens so that the intensity of light transmitted through the optical fibre is reduced by a factor of 99% compared to the intensity of light transmitted in normal use temperatures is called the transition temperature. At this temperature, the attenuation of the optical fibre reaches an attenuation threshold. In variant embodiments, the reduction factor may be set at other percentages.

The term “softening point” of the optical fibre is the temperature at which the optical fibre softens such that it can be sufficiently stretched for a wearer to remove it. This may be the temperature at which the optical fibre can be stretched under a load of SOON or less to exhibit a stretch of 1% of its length.

The transition temperature is preferably in the vicinity of the softening point of the optical fibre, or at least above the temperature to which the optical fibre is subject in normal use temperatures, which is typically about 50° C., and below about 50° C. above the softening point of the optical fibre. For example, where the softening point is 150° C., the thermochromic core material may reduce in optical transmissibility by 99% when its temperature is at least 90 degrees compared to the optical transmissibility when the core material is at normal use temperatures. In a preferred embodiment, the transition temperature is about 90° C. and there is substantially no change in attenuation between the temperature to which the optical fibre is subject in normal use and about 80° C., to ensure that accidental darkening does not occur. In another preferred embodiment, the transition temperature of the core material and the softening point of the optical fibre substantially coincide, that is, they are within about 10° C., of each other. Depending on the particular additive, the core material may darken rapidly at the transition temperature, or the core material may darken gradually.

The optical fibre 6 is connected to a sensing unit 18 in the housing 2. The sensing unit 18 is operatively connected to the controller unit 12. The controller unit 12 periodically, for example every second, causes the sensing unit 18 to send an optical signal in the form of a light pulse through the optical fibre 6. Typically, the light transmitting in the optical fibre is of wavelength between about 400 nm and 2 μm. The sensing unit 18 is also configured to receive the light pulses and provide information indicative of the intensity of the received pulses to the controller unit 12. Based on a comparison of intensity information for a pulse from the sensing unit 18 and a predetermined, stored value for the intensity of a pulse when the core is transparent, the controller unit 12 determines whether the attenuation threshold for the fibre optic is reached and, accordingly, whether an alarm condition is met.

If the intensity information for a pulse is received and the attenuation threshold is not exceeded, the controller unit 12 is configured to determine that the alarm condition is not met, since the optical fibre has not been tampered with.

If the sensing unit 18 does not receive the sent pulses, the intensity information will indicate that no pulse has been received. Plainly, if the optical fibre is broken, the sensing unit 18 will not receive pulses. The controller unit 12 is configured to determine that an alarm condition has been met. Thus, any attempt to cut or break the strap 4 to remove the tracking device will trigger the alarm condition.

If the controller unit 12 determines from received intensity information that the attenuation of the fibre optic has passed the attenuation threshold, based on the intensity of the received light pulse, stored information on the intensity that a received light pulse has in normal use temperatures and an intensity reduction factor, the controller unit 12 determines that the alarm condition is met. For example, the threshold may be a reduction of the intensity of the received light pulse to 1% of the intensity that a light pulse would have in normal use temperatures. If the received and stored information indicate that the threshold has been passed, the alarm condition is met. Notably, the actual attenuation for the optical fibre need not be calculated.

In a variant embodiment, the controller 12 is configured to determine whether the threshold attenuation is reached by comparing the received intensity information with stored intensity information on the intensity of the transmitted pulse. In another variant, information indicative of intensity may simply be compared against a predetermined, stored value representative of a particular degree of attenuation (which may be zero), and whether the alarm condition is met is based on a result of a comparison of the intensity information and the stored value.

When the alarm condition is met, the controller unit 12 is configured to send a message to the monitoring centre and/or a device under the control of a responsibility authority. Additionally or alternatively, the controller unit 12 is operatively coupled to an audible alarm. In this case, the controller unit 12 is configured to cause the audible alarm to sound.

In operation, the GPS locator 10 periodically provides data indicative of location of the electronic tag to the controller unit 12. The controller unit 12 provides the location data to the transmitter 14. The transmitter, under the control of the controller unit 12, transmits the location data to the monitoring centre 16. Contemporaneously, the sensing unit 18, under the control of the controller unit 12, periodically sends light pulses through the optical fibre 6. The sensing unit 18 provides signals indicative of received light pulses that have travelled through the optical fibre 6 to the controller unit 18. The controller unit 18 monitors the intensity of the received signals and compares the intensity to the stored value indicative of the intensity of the pulses received at normal use temperatures to determine the attenuation value for optical fibre 6. If the attenuation value is above the threshold attenuation value, for example where the intensity of the pulse is reduced to the stored value, the controller unit 14 determines that the alarm condition is met and causes the sending unit to send an alarm message to the monitoring centre 16.

In making the optical fibres described, the thermo-chromatic additive is added to the material of the core. Various different additives or combinations of additives can be used to give the core material of the optical fibre a thermo-chromatic character. The additive is selected and added to give the core material a particular transition temperature. Suitable thermochromic additives may be identified using the disclosure of an article entitled “Thermotropic and Thermochromic Polymer Based Materials for Adaptive Solar Control” by Arno Seeboth, Ralf Ruhmann and Olaf Mühling (ISSN 1996-1944) published on 6 Dec. 2010 by the Multidisciplinary Digital Publishing Institute. A suitable additive may use a ligand exchange thermo-chromatic system or use a leuco dye. For example, a two-component system for inducing thermo-chromatic character in the core material may include a leuco dye and a biphenyl developer with a long alkyl chain (4-alkoxy-4′-hydroxybiphenyl). A suitable ligand exchange thermo-chromatic system may also be identified using the disclosure of US patent publication no. US20120292581 entitled “Ligand exchange thermochromic systems and high e ligands for same”. The attenuation of the optical fibre may also depend on the length of the fibre.

The optical fibre is then made in a conventional fibre-drawing process in which a small diameter fibre is pulled from a larger preform, which is heated to a drawing point. Alternatively, the optical fibre is then made in a conventional extrusion process. Since these processes require heating of the material in order to draw or extrude the material into the form of the core, the attenuation coefficient of the core material increases. After the process is complete, the material of the core is reset by application of UV light. Alternatively, the core material may be returned to its transparent state by an alternative method. Alternatively, the additive is such that the core material only darkens temporarily. In this case, no step of returning the core material to a transparent state is required.

It will be appreciated by persons skilled in the art that various modifications are possible to the embodiments.

In variant embodiments, the fibre optic sensor may include multiple optical fibres, one, some or all of which may include the thermo-chromatic additive.

In a variant embodiment, light of two wavelengths may be transmitted through the optical fibre. The thermo-chromatic material of the optical fibre may be activatable on heating to a transition temperature to absorb only the light of one of the wavelengths. Accordingly, it can be understood from the output of the sensor elements that the optical fibre has been heated, but remains continuous.

Embodiments are not limited to an optical fibre used in such an electronic tag. Embodiments of the invention may be used in other applications where it is desired to detect a temperature change, in particular when an optical fibre is heated to a temperature in the vicinity of which it is malleable. In the field of electronic tagging, embodiments of the invention are also not limited to where an offender is tagged, but may include embodiments, in which electronic tags are attached to motor vehicles, bicycles, containers, computer equipment, animals, and persons other than offenders. It will be appreciated that materials of the optical fibre can be configured so that the transition temperature is appropriate in view of normal use temperatures.

Embodiments are not limited to tags in which location is tracked. For example, a characteristic of a person's health may be monitored, for example pulse to monitor that that person is still alive. Also, where the monitoring relates to location tracking, data indicative of location is typically transmitted from the tracking device. However, data on the parameter that is being monitored may simply be logged at the device for later retrieval.

It should be understood that herein the term “thermochromic” indicates that a substances changes colour due to a change in temperature. A change in colour corresponds to a change in opacity for at least some wavelengths.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

1. A tag for securing to a person or object, comprising:
at least one fibre optic sensor, the at least one sensor comprising:
a plastics optical fibre comprising material of which a characteristic of optical transmission changes with a change in temperature, and
a sensor unit operatively coupled to the optical fibre, wherein the sensor unit is configured to detect change in the characteristic of optical transmission;
a locking strap for securing around a portion of a person or an object to be tagged, wherein the optical fibre is coupled to the strap so as to extend with the strap around the portion.

2. The tag of claim 1, wherein the plastics, optical fibre is a thermochromic, plastics optical fibre.

3. The tag of claim 1, wherein the optical fibre is formed substantially of thermoplastic material.

4. The tag of claim 1, wherein a detectable increase in attenuation of light transmitted through the optical fibre occurs when the temperature of the optical fibre is increased from a normal use temperature to at least a threshold temperature.

5. The tag of claim 4, wherein the threshold temperature is at least 80° C.

6. The tag of claim 4, wherein the optical fibre has a softening temperature, wherein the detectable increase occurs to at least a threshold attenuation when the temperature of the optical fibre is in the vicinity of the softening temperature.

7. The tag of claim 5, wherein the softening temperature is a temperature at which a length of the material of the optical fibre softens to be stretchable by at least 1% of the length under a load of at least 100 N.

8. The tag of claim 6, wherein the softening temperature is a temperature at which the length of the material softens to be stretchable by at least 1% of the length under a load of at least 500 N.

9. The tag of claim 6, wherein the softening temperature is at least 90° C.

10. The tag of claim 6, wherein the threshold temperature is less than 50° C. above the softening temperature of the optical fibre.

11. The tag of claim 6, wherein the threshold attenuation is preferably where the capability for transmission of light is reduced to less than 10% of the original capability.

12. The tag of claim 1, wherein the optical fibre is substantially comprised of a thermoplastic material and a thermochromic additive in the thermoplastic material.

13. The tag of claim 1, further comprise a controller means operatively coupled to the at least one sensor means,
wherein the at least one sensor means is configured to detect light, and to provide information indicative of intensity of incident light to the controller means,
wherein the controller means is configured to determine, based on the received information and stored information indicative of the intensity of light transmitted into the optical fibre, whether the attenuation threshold is reached, and if so, to determine that an alarm condition is met.

14. The tag of claim 13, wherein, if the alarm condition is met, the controller means is configured to cause an alarm signal to be transmitted.

15. The tag of claim 14, wherein the tag includes a tracking device configured to transmit information indicative of location of the tag.

16. A method of making an optical fibre, wherein a characteristic of optical transmission has an initial value, the method comprising:
providing material the opacity of which changes due to a change in temperature, for forming into at least a core of an optical fibre;
forming the optical fibre from at least the thermochromic material, wherein the characteristic changes from the initial value during the forming; and
returning the characteristic to its initial value.

17. The method of claim 16, wherein said characteristic is attenuation of light of a first one or more wavelengths transmitted through the optical fibre, wherein the returning comprises applying light of second predetermined one or more wavelengths different to the light of the first one or more wavelengths to the core material.

18. The method of claim 17, wherein the light of second predetermined one or more wavelengths is ultraviolet light.

19. The method of claim 16, further comprising incorporating said optical fibre in a security tag.

20. A tag for securing to a person or object, comprising:
at least one fibre optic sensor, the at least one sensor comprising:
a thermochromic, plastics optical fibre, and
a sensor unit operatively coupled to the optical fibre, wherein the sensor unit is configured to detect change in the characteristic of optical transmission;
a locking strap for securing around a portion of a person or an object to be tagged, wherein the optical fibre is coupled to the strap so as to extend with the strap around the portion.
